(19) United States
(12) Patent Application Publication
(10) Pub. No.: US 2014/0076301 A1
(43) Pub. Date: Mar. 20, 2014

(54) DEFROSTING DEVICE

(71) Applicant: Neil Shumeng Wang, San Diego, CA (US)

(72) Inventor: Neil Shumeng Wang, San Diego, CA (US)

(21) Appl. No.: 13/619,604

(22) Filed: Sep. 14, 2012

(51) Int. Cl. A47J 39/00

(52) U.S. Cl. 126/261

(57) ABSTRACT

A defrosting device for use in a household or commercial environment to effectively defrost frozen food packages is described. The device consists of three major parts; a top shell, a bottom shell and a hinge mechanism connecting the top shell and the bottom shell to allow the top shell to rotate around the hinge to open and close relative to the bottom shell. To defrost a frozen food package, the defrosting device rests on a flat surface, such as on a countertop, and the frozen food package is sandwiched between the top shell and the bottom shell. Since resistance to heat transfer from the ambient, air and from the flat surface to the frozen food package is minimized through the paths along the top shell as well as the bottom shell, the defrosting device is able to effectively defrost frozen food packages.

### BACKGROUND OF THE INVENTION

The present invention, in general relates to a device for defrosting frozen food packages, and more particularly, to a device that can defrost frozen food packages effectively without unintentionally cooking the food and efficiently without requiring frequent human intervention or wasting water.

Food, especially meat or fish products is frozen to prolong shelf life and to provide convenience. Food in general and meat or fish in particular can only be kept in room temperature for hours before perishing and becoming inedible. However, in frozen condition, it can be kept relatively fresh and unspoiled for weeks or even months. Further, in modern day lives, especially in busy urban lives, having food in freezer also provides tremendous convenience; getting food straight out from a freezer to prepare a meal instead of having to stop at a grocery shop is a part of modern day lives.

However, frozen food, especially meat or fish can't be cooked starting from its frozen state without significantly sacrificing the taste. Instead, it is typically required that frozen food be defrosted to near room temperature before being cooked. Therefore, one option of having frozen food ready for cooking at the end of day is preparation work the night or even days before actual cooking takes place; taking frozen food out of a freezer into the refrigerator section for gradual defrosting. Alternatively, one can rely on a microwave oven with its defrosting feature. A typical microwave oven will defrost frozen food or meat relatively quickly, but quite likely, it will also partially cook the out layer of the frozen food in the process unless one turns and flips the frozen food relatively frequently such as every few tens of seconds.

Defrosting can also be accomplished by submerging frozen food packages in a pool of water. With limited amount of water in the pool, and especially with water being still, complete defrosting will likely take long time or will require frequent replacement of water. To overcome this deficiency, people place frozen food packages under running tap water to shorten the defrosting time by improving heat transfer between frozen food packages and water. Obviously, the efficiency of this defrosting process is dependent upon use of water; faster defrosting will inevitably require more use or waste of water.

In summary, existing ways of defrosting frozen food packages all have deficiencies. Microwave oven can defrost frozen food packages quickly, but tend to partially cook food unintentionally. Human intervention with frequent turning of food can avoid partial cooking, but is labour intensive thus not desirable. A still water pool cannot defrost frozen food packages quickly while use of running water to defrost improves defrosting efficiency but results in waste of precious water.

Therefore, there exists a need for a device to defrost frozen food packages, especially meat or seafood effectively and efficiently.

### BRIEF SUMMARY OF THE INVENTION

The primary objective of the present invention is to provide a defrosting device that can effectively, efficiently and conveniently defrost frozen food packages, such as a steak or a fish filet packaged in a Ziploc bag. The device has a shape generally in the form of a clam shell consisting of a top shell and a bottom shell and a hinge mechanism connecting two shells to allow the top shell to rotate around the hinge to open and close relative to the bottom shell. For practical use, the device with the bottom shell resting on a flat surface such as kitchen countertop is exposed to the ambient air, and a frozen food package is placed between the top and bottom shells. Because the design described below minimizes the thermal resistance between the frozen food package, the device and the ambient, the frozen food package is quickly defrosted as heat in the ambient air as well as in the countertop surface can quickly transfer to the frozen food package.

The various objectives and advantages of the present invention will be more readily understood from the following detailed description when read in conjunction with the appended drawings.

### BRIEF DESCRIPTION OF THE SEVERAL VIEWS OF THE DRAWING

The invention is described in greater detail hereinafter by reference to the accompanying drawings wherein:

FIG. 1 is a schematic diagram of a side view and a top view of the defrosting device with a top shell and a bottom she in a partial open position.

FIG. 2 is a schematic diagram of the defrosting device with the top shell and the bottom shell in a closed position.

FIG. 3 is a schematic diagram of the defrosting device with the top shell and the bottom shell in a closed position and a frozen food package sandwiched between the top shell and the bottom shell.

FIG. 4 is a schematic diagram of the defrosting device with the top shell in several different open positions relative to the bottom shell that rests on a flat surface.

FIG. 5 is a schematic diagram of the first embodiment of the top shell in an exploded view illustrating the major parts and relative positions.

FIG. 5a is a schematic diagram of the first embodiment of the top shell with a flat top surface.

FIG. 5b is a schematic diagram of the embodiment of he top shell with a top side that has extended surface area.

FIG. 6 is a schematic diagram of the first embodiment of the bottom shell in an exploded view illustrating the major parts and relative positions.

FIG. 7 is a schematic of the bottom shell resting on a countertop surface with a thermally conductive interface material attached to the bottom side of the bottom shell.

FIG. 8 is a schematic diagram of the second embodiment of the top shell and the bottom shell in exploded views illustrating the major parts and relative positions.

FIG. 9 is a schematic diagram of the third embodiment of the top shell and the bottom shell in exploded views illustrating the major parts and relative positions.

### DETAILED DESCRIPTION OF THE INVENTION

A defrosting device for use in a home or a commercial environment to quickly defrost a frozen food package in accordance with the present invention has a plurality of parts and elements which will be identified herein below.

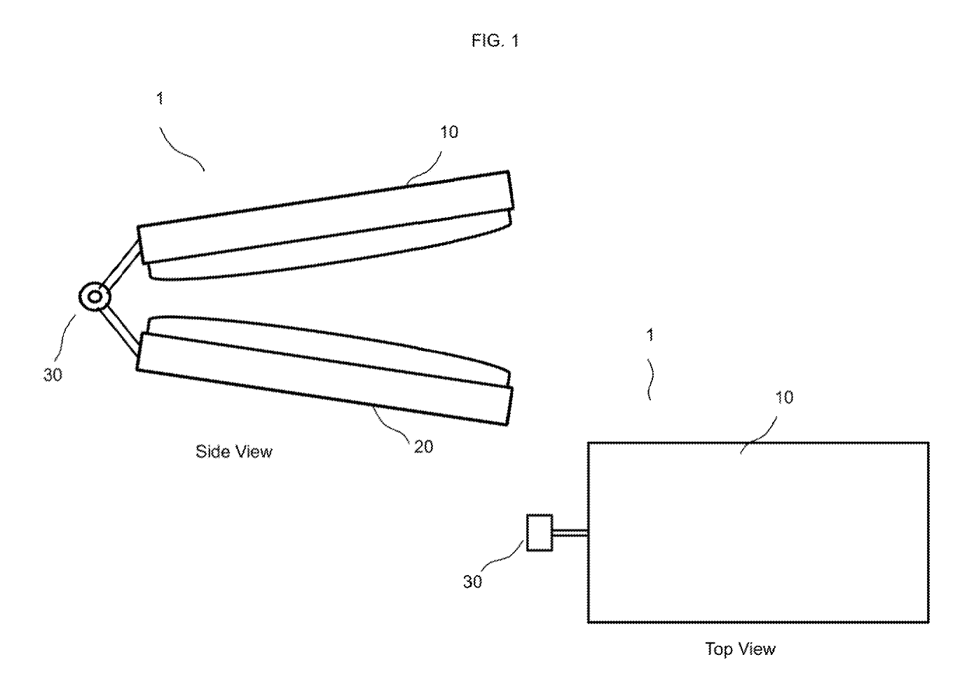

Referring to FIG. 1 the defrosting device 1 comprises a top shell 10, a bottom shell 20, and a pivotable hinge 30 that joins the top shell 10 and the bottom shell 20 to allow the top shell 10 to rotate around the pivotable hinge 30 top open and close relative to the bottom shell 20. As the top view of the defrosting device 1 illustrates that the top shell 10 and the bottom shell 20 both have a generally rectangular cross section area.

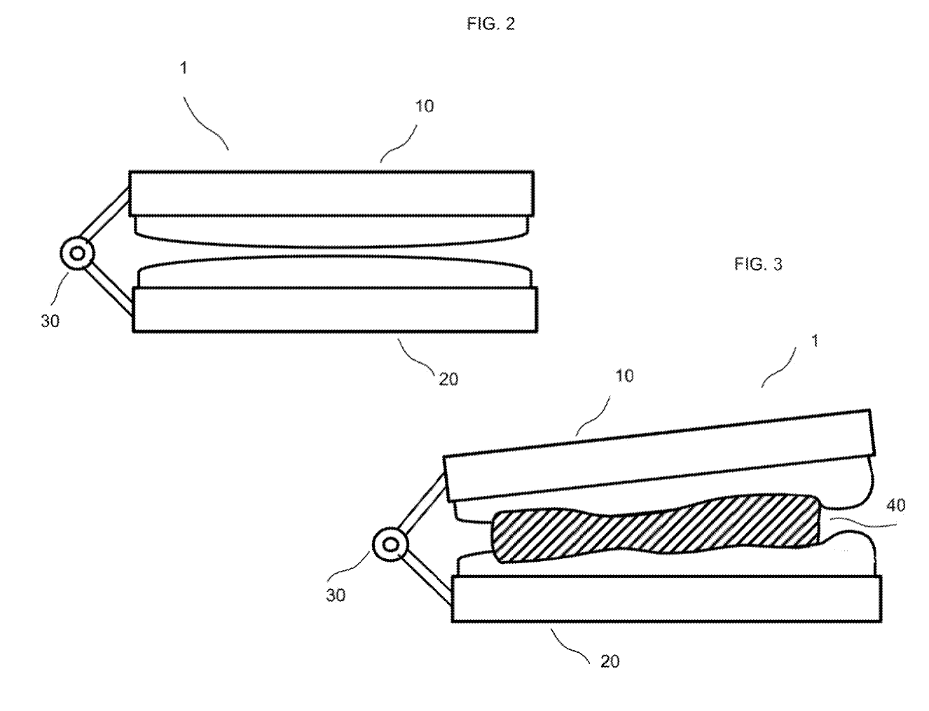

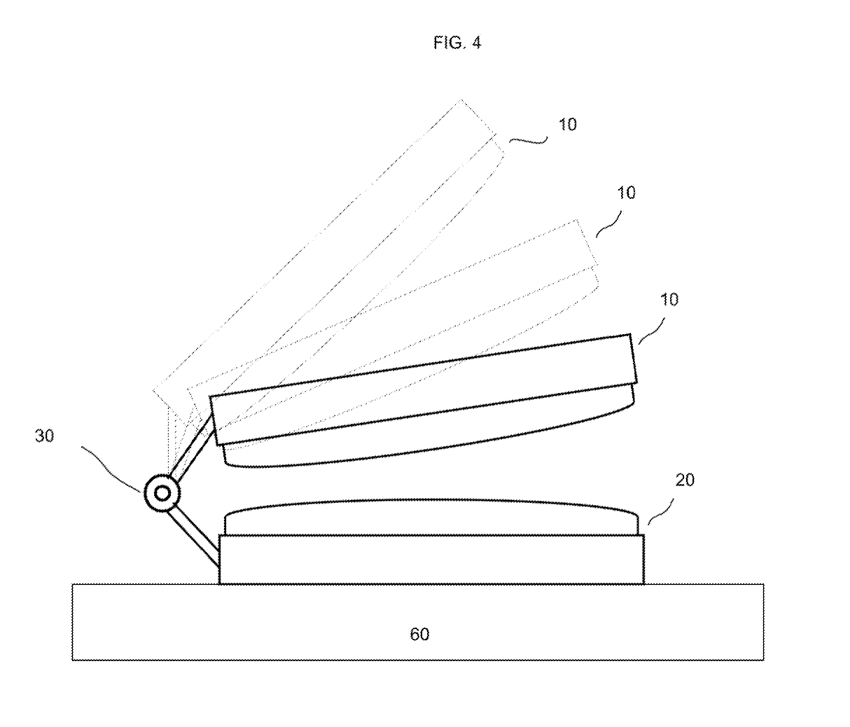

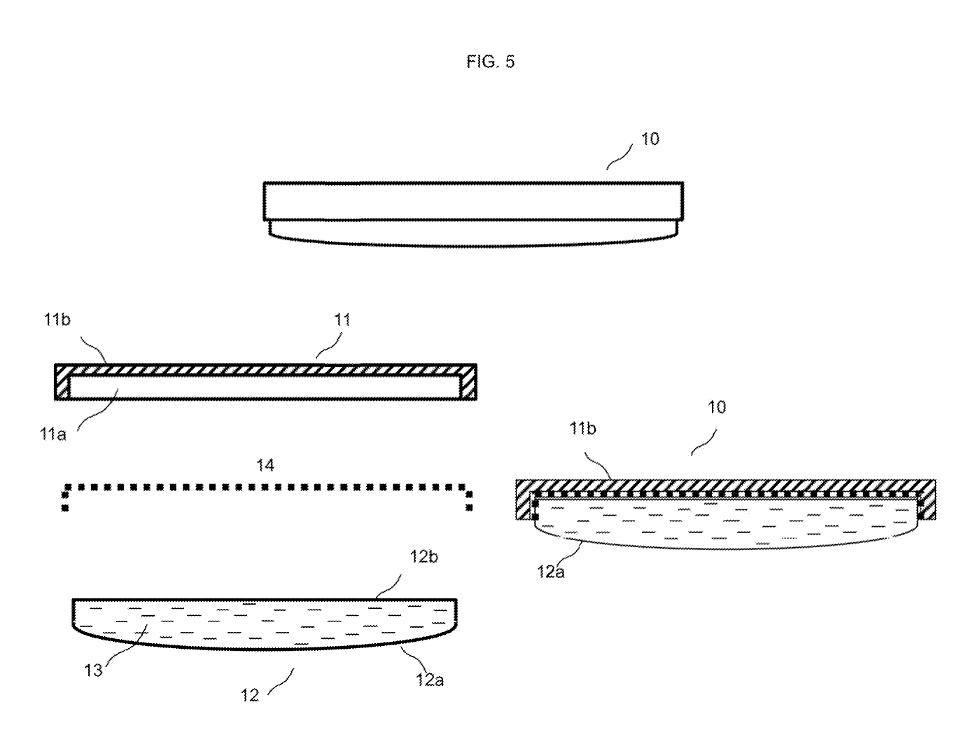

FIG. 1 shows the device 1 with the top shell 10 and the bottom shell 20 in a partially open position. FIG. 2 shows the device 1 with the top shell 10 and the bottom shell 20 in a closed position. FIG. 3 shows the device 1 in a closed position with a frozen food package 40 sandwiched between the top shell 10 and the bottom shell 20. FIG. 4 illustrates how the device 1 with the bottom shell 20 resting on a stationary and generally flat surface 60 and the top shell 10 opens at various positions in relation to the bottom shell 20 around the hinge 30.

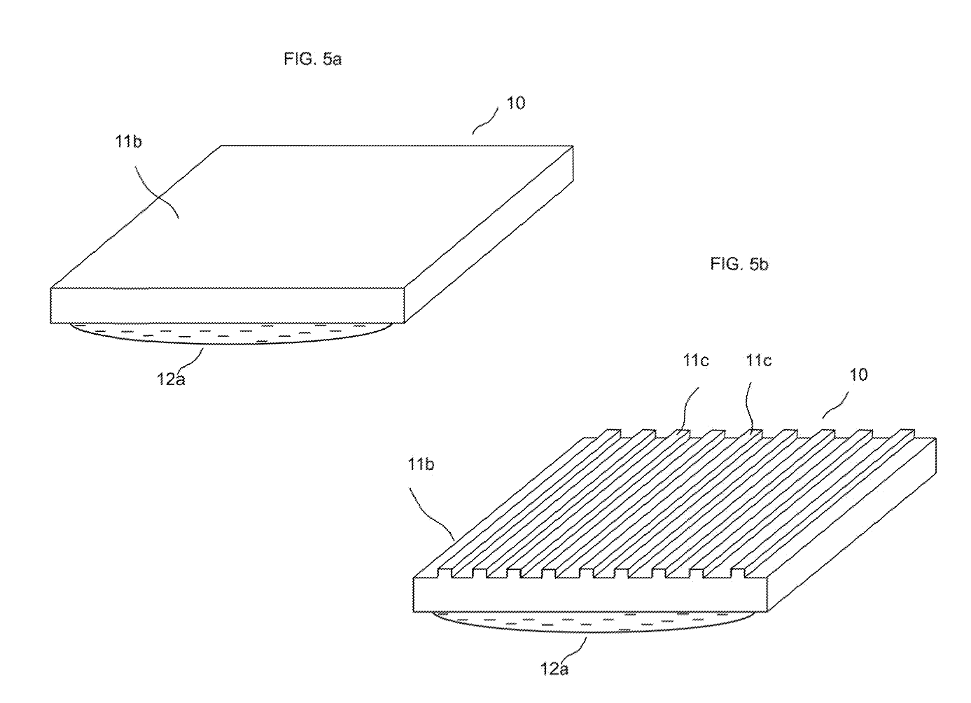

FIG. 5 illustrates the details of the top shell 10 which consists of an upper casing 11 with a downward facing cavity 11a and an upper surface 11b and a hermetically sealed pouch 12 with an upper side 12b and a downside 12a. The cavity of the pouch 12 is filled with a liquid 13 such as water. The upper side 12b of the pouch 12 is attached to the inside of the cavity 11a with an adhesive material 14 to form the top shell 10 with the downside 12a that will come into direct contact with a frozen food package, and the upper surface lib in a shape that is significantly rectangular as illustrated in the top view in FIG. 1 that is exposed to ambient air.

The purpose of the defrosting device 1 is to defrost a frozen food package 40 by effectively transferring heat from ambient around the defrosting device 1 to the frozen food package 40 that is sandwiched between the top shell 10 and the bottom shell 20 as shown in FIG. 3, The key to achieve this goal therefore is to minimize the resistance to heat transfer across the entire heat transfer paths.

For the top shell 10, the heat transfer path is from outside air, to and through the casing 11, through the adhesive material 14, through the top out layer 12a, through the filler liquid 13, through the bottom out layer 12b, through the air gap, if any between 12b and the frozen food package 40 and through and into the frozen food package 40.

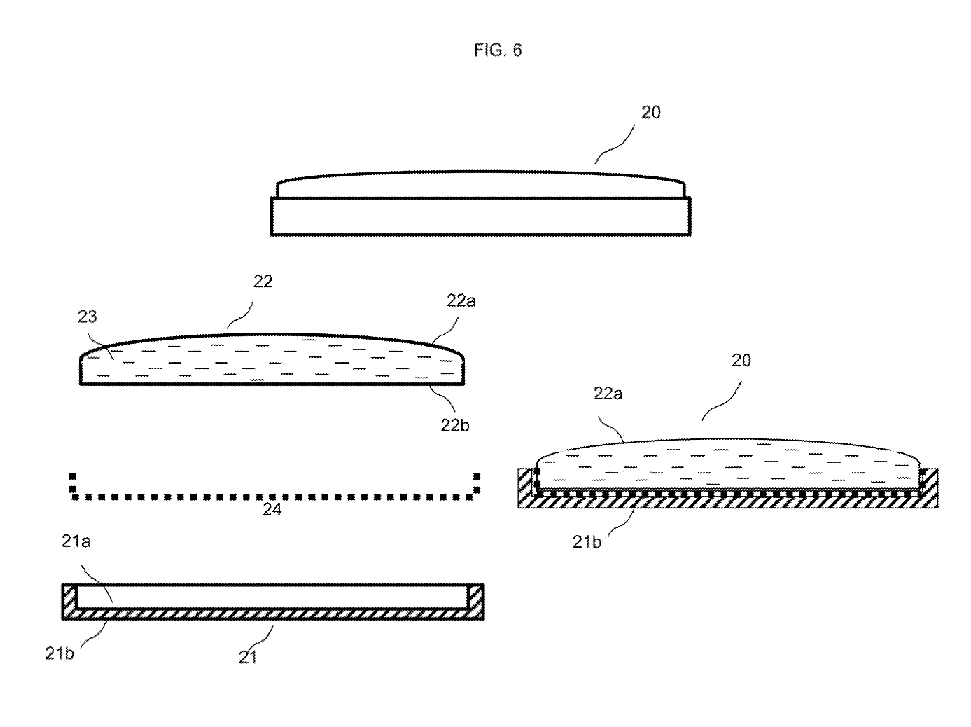

The outside surface 11 b can be flat as shown in FIG. 5a or, to enhance heat transfer, be preferably manufactured with fins or extended surfaces 11c like a heatsink as illustrated in FIG. 5b. The upper casing 11 is preferably made of a material that is thermally conductive such as copper to effectively transfer heat through the casing 11. Further, the upper casing 11 is preferably heavy to press the pouch 12 to come into better contact with the frozen food package 40. Between the inside surface 11a and the upper surface 12b, the adhesive material 14 is preferably thermally enhanced, such as thermally conductive epoxy. The filled liquid 13 is also desirably thermally enhanced which can be achieved, among other methods, by adding salt or other thermally conductive particulate materials such as copper or aluminum powder into water. Since the downside 12a of the pouch 12 will be in direct contact with the frozen food package 40, the out layer of the pouch 12 is preferably made of a material that is flexible and soft so as to easily conform to typically irregular shape and contour of the frozen food package 40 to ensure maximum contact surface to minimize thermal resistance between the pouch 12 and the frozen food package 40. The pouch material is also preferably thin to minimize thermal resistance from the frozen food 40 to the filler liquid 13. Further, the pouch 12 must be made of a durable material so as to sustain a reasonable useful life. FIG. 6 shows the bottom shell 20 which is substantially similar in structure to that of the top shell 10. The bottom shell 20 includes a bottom casing 21 with an upward facing cavity 21a and bottom surface 21b and a hermetically sealed pouch 22 that is filled with a liquid 23 such as water. The bottom casing 21 is preferably made of a material that is thermally conductive such as copper to effectively transfer heat through :20 the casing 21. The bottom side 22b of the pouch 22 is attached of the upward facing cavity 21a with a thermally conductive adhesive material 24 for form the bottom shell 20. The filled liquid 23 is also desirably thermally enhanced which can be achieved, among other methods, by adding salt or other thermally conductive particulate materials such as copper or aluminum powder into water. Since the upper side 22a of the pouch 22 will be in direct contact with the frozen food package 40, the out layer of the pouch 22 is preferably made of a material that is flexible and soft so as to easily conform to typically irregular shape and contour of the frozen food package 40 to ensure maximum contact surface to minimize thermal resistance between the pouch 22 and the frozen food package 40. The pouch material is also preferably thin to minimize thermal resistance from the frozen food 40 to the filler liquid 23. Further, the pouch 22 must be made of a durable material so as to sustain a reasonable useful life.

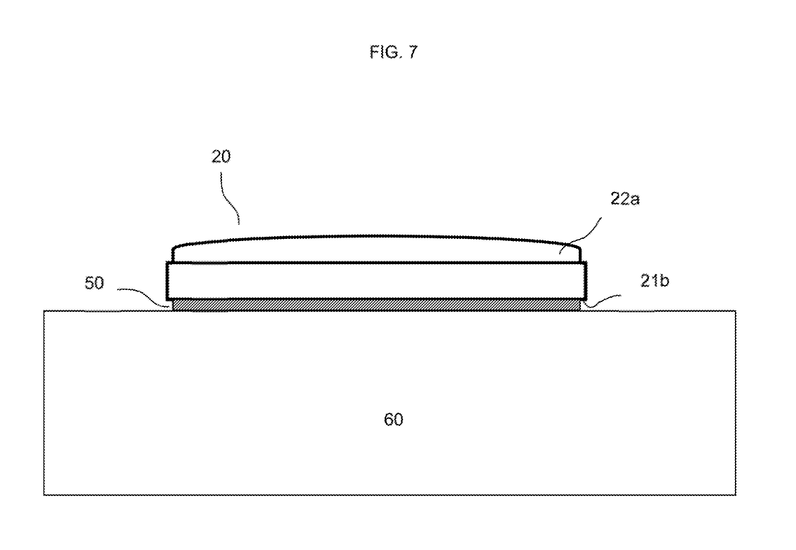

For practical purposes, the top shell 10 and the bottom shell 20 can have the dimensions that are substantially the same. The bottom surface 21b has a rectangular cross section area as illustrated in the top view in FIG. 1. Unlike the top surface 11b of the top shell 10 that is exposed directly to ambient air, the bottom surface 21b of the bottom casing 21 generally rests on a flat surface 60 such as kitchen countertop as illustrated in FIG. 7. Therefore, the bottom surface 21b of the bottom casing is preferably flat to match the flat surface of a countertop. It is also desirable to enhance heat transfer between the bottom surface 21b and the counter top 60 that the defrosting device 10 rests on. To achieve this goal, a thermal interface material 50, such as ERG's Duocel® thermally conductive foam, is attached to and significantly covers the bottom side 21b of the bottom casing 21.

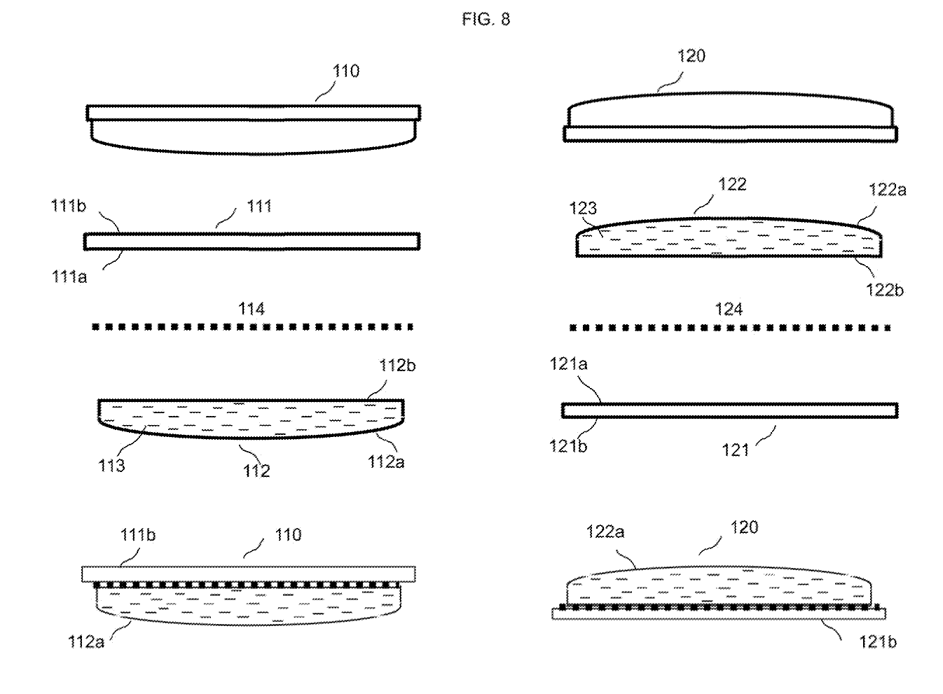

FIG. 8 illustrates a second embodiment of the top shell 110 and the bottom shell 120. The top shell 110 is made of a plate 111 with a bottom side 111a and a top side 111b and a hermetically sealed pouch 112 that has a top side 112b and a bottom side 112a. The bottom side 111a of the plate 111 is bonded to the top side 112b of the pouch 112 with a thermally conductive adhesive material 114. The bottom shell 120 is significantly the same as the top shell 110 in its physical dimensions as well as construction.

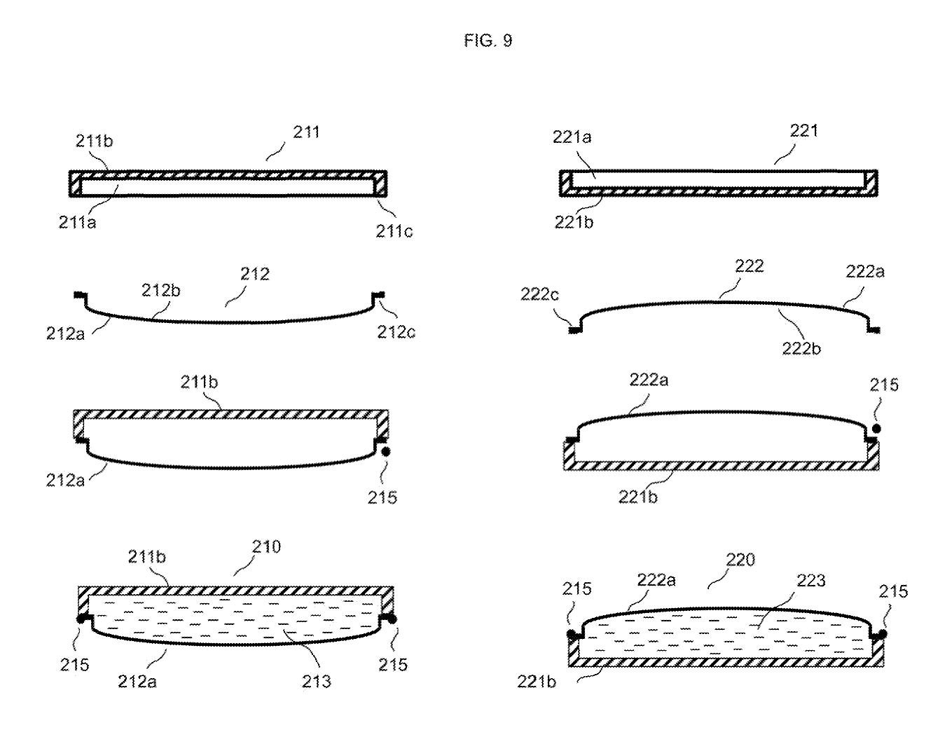

FIG. 9 illustrates a third embodiment of the top shell 210 and the bottom shell 220. The top shell 210 is made of a casing 211 with a downward facing cavity 211a, a top side 211b and a continuous and coplanar rim 211c. A convex membrane 212 has a top side 212b, a bottom side 212a and a flange 212c which is sized to completely cover the casing rim 211c. The cavity between the top shell 210 and the membrane 212 is made to be water tight with a sealant material 215 covering and sealing the membrane flange 212c to the casing rim 211c. The cavity is then filled with a filler liquid 213. The construction of bottom shell 220 is significantly the same as that of the top shell 210.

While the invention and exemplary embodiments of the invention have been illustrated and described in general and specific terms, it should be understood that the invention may be modified and otherwise embodied in still other forms, including but not limited to all forms which are obvious variants of or equivalent to those disclosed.

The preceding descriptions are by way of example and are not intended to limit or restrict the scope of the invention which is specified and defined by the appended claims.

While the invention and exemplary embodiments of the invention have been illustrated and described in general and specific terms, it should be understood that the invention may be modified and otherwise embodied in still other forms, including but not limited to all forms which are obvious variants of or equivalent to those disclosed.

The preceding descriptions are by way of example and are not intended to limit or restrict the scope of the invention which is specified and defined by the appended claims.

I claim:

1. A defrosting device resting on a significantly flat surface for use to defrost a frozen food package, comprising:
A top shell comprising a top side that is substantially exposed to ambient air, a bottom side, a hermetically sealed top cavity formed by said top side and said bottom side, and a liquid material significantly filling said top cavity; wherein said bottom side comes into direct contact with said frozen food package that is positioned underneath said top shell;
A bottom shell comprising a bottom side that rests on said flat surface, a top side, a hermetically sealed bottom cavity formed by said bottom side and said top side, and a liquid material significantly filling said bottom cavity; wherein said top side comes into direct contact with said frozen food package that rests on said top side of said bottom shell;
A hinge mechanism connecting said top shell and said bottom shell to allow said top shell to rotate around said hinge mechanism to open and close in relation to said bottom shell

2. A defrosting device as defined in claim 1, wherein said liquid material that fills said top cavity and said bottom cavity is preferably at least partially filled with at least one particulate material whose thermal conductivity is higher than that of said liquid material.

3. A defrosting device as defined in claim 1, wherein said top side of said top shell is preferably made of a substantially rigid and thermally conductive material.

4. A defrosting device as defined in claim 3, wherein said top side of said top shell includes at least one fin to increase surface area.

5. A defrosting device as defined in claim 1, wherein said bottom side of said top shell is preferably made of a durable and flexible material such that said bottom side of said top shell can significantly conform to the shape and contour of said frozen food package resting underneath said top shell.

6. A defrosting device as defined in claim 1, wherein said bottom side of said bottom shell is preferably made of a substantially rigid and thermally conductive material.

7. A defrosting device as defined in claim 6, wherein said bottom side of said bottom shell is substantially covered with a thermally conductive interface material to minimize thermal resistance between said bottom side of said bottom shell and said flat surface upon which said defrosting device rests.

8. A defrosting device as defined in claim 1, wherein said top side of said bottom shell is preferably made of a durable and flexible material such that said top side of said bottom shell can significantly conform to the shape and contour of said frozen food package resting on top of said bottom shell.
